(19) United States
(12) Patent Application Publication
(10) Pub. No.: US 2007/0197322 A1
(43) Pub. Date: Aug. 23, 2007

(54) Method for improving the towing suitability of a motor vehicle equipped with a belt-driven conical-pulley transmission, and a conical disk pair

(75) Inventor: Hartmut Faust, Buhl (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 11/645,088

(22) Filed: Dec. 21, 2006

Related U.S. Application Data
(60) Provisional application No. 60/752,700, filed on Dec. 21, 2005.

(51) Int. Cl. F16H 61/00; F16H 55/56

(52) U.S. Cl. 474/28; 474/18; 474/8

(57) ABSTRACT

A conical disk pair for a belt-driven conical-pulley transmission includes an input shaft that is rigidly connected to a fixed disk, a movable disk that is axially movable on the shaft and rotationally fixed, an input component drivable by a drive engine. A torque sensing unit operatively connected with the movable disk includes a first component that is engaged with the input component to transmit torque and that has first shaped surfaces, and a second component that is engaged with the movable disk to transmit torque and that has second shaped surfaces, and rolling bodies positioned between the shaped surfaces. The shaped surfaces are designed in such a way that when a force pushing them together is small or is absent, the rolling elements overrun the shaped surfaces and the transmission of torque between the first component and the second component is interrupted.

### BACKGROUND OF THE INVENTION

1. Field of the Invention

The present invention relates to a method for improving the towing suitability of a motor vehicle equipped with a belt-driven conical-pulley transmission. The invention also relates to a conical disk pair for a belt-driven conical-pulley transmission.

2. Description of the Related Art

Belt-driven conical-pulley transmissions, such as are employed for example in motor vehicles, generally contain two pairs of conical disks between which is carried an endless torque-transmitting means, for example a plate-link chain. By changing the spacing between the conical disks of each conical disk pair in opposite directions, the transmission ratio of the transmission can be varied continuously.

One problem in motor vehicles equipped with such a belt-driven conical-pulley transmission is that in the event the drive engine of the vehicle becomes inoperative, towing is only possible within narrowly defined conditions in order that no damage occurs, in particular due to a lack of oil pressure or hydraulic fluid pressure supply. When towing with the engine stopped, and the hydraulic pump thus not being driven to provide hydraulic pressure, in conventional belt-driven conical-pulley transmissions almost the entire power train is driven by the vehicle wheels to a start-up clutch or to a torque converter. Because of a lack of lubrication, transmission damage can occur, in particular to clutches, planetary gear sets (usually in the form of reversing sets for driving in reverse), bearings, etc., if the strict requirements relating to maximum driving speed and maximum driving distance are not adhered to.

An object of the invention is to reduce the towing problems that exist when motor vehicles equipped with a belt-driven conical-pulley transmission are towed.

### SUMMARY OF THE INVENTION

The object is achieved with a method for improving the towing suitability of a motor vehicle equipped with a belt-driven conical-pulley transmission. In the method in accordance with the invention a torque-transmitting engagement between the belt-driven conical-pulley transmission and the drive engine of the motor vehicle is interrupted when there is torque acting from the vehicle wheels into the belt-driven conical pulley transmission and there is no hydraulic pressure acting on the transmission.

Advantageously, the torque-transmitting engagement is restorable again by applying hydraulic pressure to the belt-driven conical-pulley transmission.

The above-identified object of the invention is also achieved with a conical disk pair for a belt-driven conical-pulley transmission. The conical disk pair includes an input shaft that is rigidly connected to a fixed disk, a movable disk that is axially movable on the input shaft and is rotationally fixed to the shaft, an input component drivable by a drive engine, and a torque sensing unit. The torque sensing unit includes a first component that is engaged with the input component in a manner that transmits torque and that has first shaped surfaces, and it also includes a second component that is engaged with the movable disk in a manner that transmits torque and that has second shaped surfaces. Rolling bodies are positioned between the shaped surfaces, and the unit is designed in such a way that as the torque acting between the shaped surfaces increases, the shaped surfaces move away from each other against a force pushing the shaped surfaces toward each other, rolling on the rolling bodies positioned between them. The shaped surfaces are formed in such a way that they move away from each other when a force pushing them together is small or lacking, in such a way that the rolling bodies overrun the shaped surfaces and the transmission of torque between the first component and the second component is interrupted.

The conical disk pair in accordance with the invention can be designed so that the transmission of torque is interruptible only when there is torque acting from the movable disk.

Advantageously, the first component is an annular component connected in a rotationally fixed connection with an input wheel mounted on the input shaft. The first component has an end face facing away from the input wheel and on which end face the first shaped surfaces are formed. The second component is a piston that surrounds the input shaft and is axially movable relative to the input shaft. A pressure chamber is provided between the piston and the movable disk, into which a supply channel to which hydraulic fluid pressure can be applied leads from the fluid pressure source and from which a discharge channel leads. The effective cross-sectional area of an input and/or a discharge opening for the hydraulic fluid can be varied by the axial position of the sensing piston.

The rolling elements are preferably in the form of balls held in a cage.

The shaped surfaces can give way radially outwardly to tracks formed without ramps. The balls are radially movable, so that when there is no hydraulic pressure and at high rotational speeds the balls run on substantially flat tracks as a consequence of centrifugal force.

The balls can be biased axially in the direction of pockets that are formed in the first or second shaped surfaces, in order to prevent the balls from constantly running against ramps of the shaped surfaces when the transmission of torque is disengaged.

### BRIEF DESCRIPTION OF THE DRAWINGS

The structure, operation, and advantages of the present invention will become further apparent upon consideration of the following description, taken in conjunction with the accompanying drawings in which:

FIG. 1 is a longitudinal cross-sectional view of a conical disk pair of a belt-driven conical-pulley transmission including a torque sensor;

FIG. 2 is an enlarged detail of a portion of the torque sensor shown in FIG. 1;

FIG. 3 is a fragmentary cross-sectional view of shaped roller surfaces of the torque sensor at their closest proximity to each other; and

FIG. 4 is a view similar to FIG. 3, with the shaped roller surfaces shifted relative to each other, as compared to the view in FIG. 3, as a result of relative rotation.

### DESCRIPTION OF THE PREFERRED EMBODIMENTS

A belt-driven conical-pulley transmission, on the basis of which the invention will now be explained in exemplary form, is described in terms of its basic structure in the article entitled “multitronik-Das neue Automatikgetriebe von Audi” (Multitronic-The New Automatic Transmission from Audi) on page 548ff of the German publication ATZ-Automobiltechnische Zeitschrift, 102 (2000) 718.

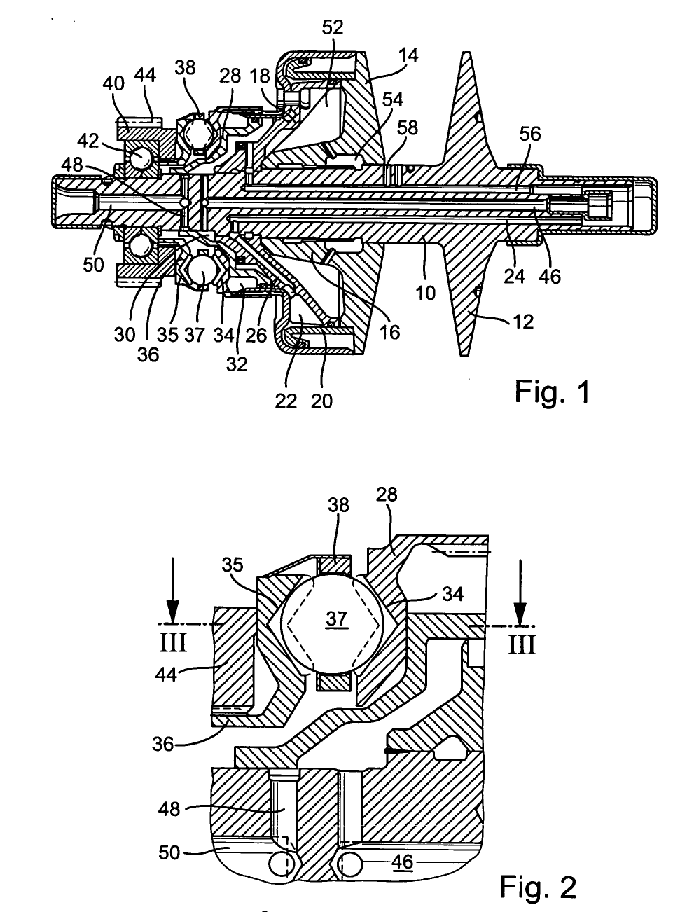

As shown in FIG. 1, a pair of conical disks of such a belt-driven conical-pulley transmission has an input shaft 10 that is made in one piece with a fixed disk 12. Positioned on shaft 10, in an axially movable but rotationally fixed connection, and axially opposite to the fixed disk is a movable disk 14. An endless torque transmitting means (not shown) runs between the conical surfaces of the disks and the conical surfaces of another pair of conical disks (not shown).

In the position illustrated in FIG. 1, in which movable disk 14 is moved as far as possible to the left, as viewed relative to the figure, an annular flange 16 of the movable disk, by which flange the movable disk 14 is guided on the input shaft 10 so that it is axially movable but rotationally fixed, has its left-end face in contact with a support ring 18 that is rigidly connected to shaft 10. The support ring ends in an annular chamber that in its radially outer region is open toward movable disk 14, within which annular chamber a piston 20 that is rigidly connected to movable disk 14 is axially movable and sealed. Between piston 20 and support ring 18 is an adjusting chamber 22, which is connected through an axial channel 24 formed in shaft 10 and through a radial bore in shaft 10 and a circumferential groove to a supply conduit 26 that is connected with axial channel 24 and extends through support ring 16. Adjusting chamber 22 is connected to a source of hydraulic pressure to adjust the transmission ratio of the transmission by adjusting the distance between movable disk 14 and fixed disk 12.

Positioned on shaft 10 on the side of support ring 18 facing away from movable disk 14, and axially movable, is a sensing piston 28, which is connected to support ring 18 so that it is axially movable and rotationally fixed. On their sides facing each other sensing piston 28 and support ring 18 are shaped in such away that a radially inner pressure chamber 30 and a radially outer pressure chamber 32 are formed between them, whose volume changes when sensing piston 28 is moved axially.

On its rear side, facing away from movable disk 14, sensing piston 28 includes a circumferential shaped surface 34 that is completely annular, and opposite which another shaped surface 35 of an annular component 36 is positioned. Positioned between shaped surfaces 34 and 35 are rolling bodies, in the form of balls 37 in the illustrated example, which are retained by a cage 38.

The balls 37, together with shaped surfaces 34 and 35, form a torque sensor, the upper half of which is circled in FIG. 1. Annular component 36 is connected rigidly or through a toothed arrangement to an input wheel 40, which is mounted on shaft 10 by means of a bearing 42 so that it is axially immovable. Annular component 36 has outside teeth 44, by which it can be driven rotationally by a connection to a drive engine (not shown).

Radially inner pressure chamber 30 is connected through radial bores to an axial channel 46 of shaft 10, which axial channel 46 can be subjected to hydraulic pressure from a hydraulic pump. In addition, pressure chamber 30 is connected to a discharge channel 50 through radial discharge bore 48. The radially inner pressure chamber 30 is connected by passageways (not shown) to a pressure chamber 52 that is formed between support ring 18 and movable disk 14, radially inward of adjusting chamber 22. Pressure chamber 52 is connected by passageways in movable disk 14 to an annular chamber 54 that is formed between movable disk 14 and shaft 10. The radially outer pressure chamber 32 is connected by radial passageways, that lead through the support ring 18 and the shaft, with an additional axial channel 56 in the shaft, from where, in the illustrated position of the movable disk 14, radial channel 58 that is not covered by the movable disk leads into the free space between the conical disks 14 and 12.

The function of the conical disk pair described up to now is known, and will therefore be explained only briefly:

FIG. 1 shows the position of the conical disk pair with the greatest possible spacing between disks 12 and 14. Let it be assumed that axial channel 46 is subjected to hydraulic pressure, which operates in the radially inner pressure chamber 30 and forces sensing piston 28 to the left, as viewed in FIG. 1. If input wheel 40 is driven by a drive engine, torque is transmitted from the shaped surface 35, which has a rotationally fixed connection with the input wheel, via the balls 37 to the shaped surface 34 of sensing piston 28. As a result, because the balls 37 move along ramps of at least one of the shaped surfaces 34 and 35, the distance between the shaped surfaces becomes larger and sensing piston 28 moves to the right, as viewed in FIG. 1. As that happens, the sensing piston increasingly closes discharge bore 48, which leads into discharge bore 50, which, in turn, causes the pressure in the radially inner pressure chamber 30 to rise, so that the pressing force with which movable disk 14 is forced in the direction of fixed disk 12 increases and is proportional overall to the effective torque. If movable disk 14 is pushed to the right, in particular by applying hydraulic pressure to the adjusting chamber 22, annular chamber 54, which is connected to pressure chamber 52, begins to overlie radial channel 58, whereby the radially outer pressure chamber 32 is also subjected to pressure, so that the torque required to move sensing piston 28 to the right increases. The torque sensor formed by the shaped surfaces and the balls thus has a progression that depends on the transmission ratio.

In conventional belt-driven conical-pulley transmissions the relative rotatability between the shaped surfaces 34 and 35 is limited by an axial stop of sensing piston 28 and/or by protuberances formed at the ends of ramps of the shaped surfaces, so that no rolling element or no ball is able to overrun a ramp and end up in the pocket of the next ramp. The result is that when the transmission is towed, i.e., in particular when the drive engine is stopped and as a result there is no hydraulic pressure supply, the sensing piston, which is moved completely to the right as viewed in FIG. 1, because of the absence of hydraulic pressure, drives the input wheel 40 with the balls 37 therebetween, and the components connected in series with it, such as clutches, planetary gear sets, etc. in rotational motion with it, as far as the startup clutch, which causes the limitations in terms of towing ability of the vehicle identified at the outset.

In accordance with the invention, the torque sensor is therefore designed so that it interrupts the flow of torque when there is inadequate hydraulic pressure in the radially inner pressure chamber 30, or in both pressure chambers 30 and 32, so that there is no transmission of torque from movable disk 14 to input wheel 40.

FIG. 2 shows an enlarged cross-sectional view of a portion of Figure showing the several parts of the torque sensor.

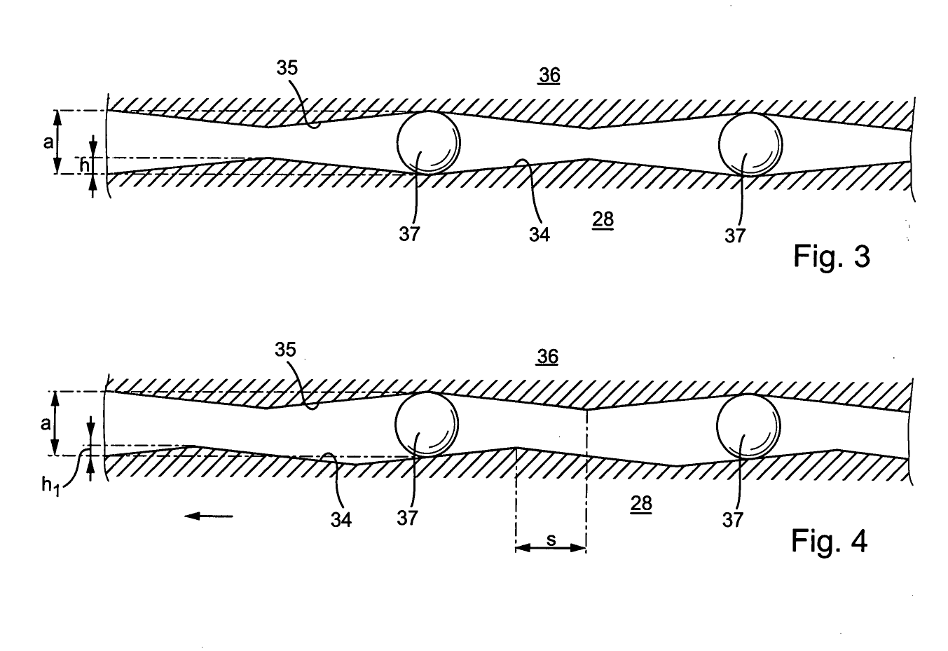

FIG. 3 shows a development of the shaped surfaces at the level of the plane III-III of FIG. 2 at a no torque condition. FIG. 4 shows the view of FIG. 3 with torque present.

In FIG. 2 it is clearly visible how the balls 37 are held between the shaped surfaces 34 and 35 by a cage 38, cage 38 being supported on the outer rim of annular component 36 by a lateral projection.

FIG. 3 shows the developed opposed shaped surfaces 34 and 35, with no torque present between the sensing piston 28 and the annular component 36, so that the shaped surfaces are at the closest proximity to each other and the balls 37 are held in the opposing depressions or pockets of each shaped surface. The distance between the balls is determined by the cage 38.

Now if, in accordance with FIG. 4, a torque directed toward the left in accordance with the arrow is exerted on the sensing piston 28 when the vehicle is towed, it results in sensing piston 28 twisting relative to annular component 36 in the direction of the arrow (by the distance s measured in the circumferential direction in the illustrated condition), which causes the ramps of shaped surface 34 to move relative to the balls 37. In the illustrated condition, shaped surface 34 has moved relative to shaped surface 35 by a distances measured in the circumferential direction, which has caused the components 28 and 36 to be separated from each other by the distance h-h₁. If the distance by which sensing piston 28 can move away from annular component 36 is greater than the dimension h (the height of a ramp), shaped surface 34 can rotate relative to shaped surface 35 without there being any transmission of torque, since the peaks of the ramps are able to move past the balls. In that way the transmission of torque is interrupted during towing.

If the torque operates from annular component 36, shaped surface 35 moves in the direction opposite that shown by the arrow in FIG. 4. Because of the symmetrical design of the shaped surfaces, interruption of the transmission of torque is possible in that case as well when there is too little pressing force of sensing piston 28 in the direction of the annular component 36, so that the belt-driven conical-pulley transmission is protected against slipping of the endless torque-transmitting means when there is too little pressing force, which would otherwise cause severe wear.

Because the shaped surfaces are designed asymmetrically in reference to the circumferential direction, the type of torque interruption can differ with the vehicle being towed or propelled. For example, by integrating a free wheeling device the shaped surfaces can be designed so that an interruption of torque occurs only when the vehicle is towed, and is prevented when the vehicle is being propelled.

As soon as enough hydraulic pressure is present, the normal torque transmission function between the annular component 36 and the sensing piston 28 begins again.

To avoid a constantly recurring impact of the balls moving past a ramp peak onto the following ramp, the balls can be guided radially in cage 38 in such a way that they move radially toward the outside, away from ramp regions of the shaped surfaces to tracks or rolling circles lying farther toward the outside, along which they circulate on predominantly flat running surfaces.

Alternatively, cage 38 can be pulled axially to one side by additional spring elements, for example, so that the balls remain secure in the pockets of the shaped surface 36 in accordance with FIG. 4.

An additional advantage that is achieved with the design of the torque sensing unit in accordance with the invention consists in the fact that an additional spring, for example a diaphragm spring, which is usually contained in the pair of disks driven by the drive engine, can be dispensed with. A spring that is usually present in the disk pair on the power output side of the transmission can also be eliminated or be of a weaker design.

The invention can be employed with practically all belt-driven conical-pulley transmissions in which the torque is transmitted from the drive engine to the belt-driven transmission through a torque sensor that is integrated into the belt-driven transmission, wherein the torque sensor operates with shaped or ramp surfaces that are supported against each other by rolling bodies, those shaped or ramp surfaces being tiltable relative to each other and changeable in their axial distance from each other.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A method for improving the towing suitability of a motor vehicle equipped with a belt-driven conical-pulley transmission, said method comprising the steps of: providing a motor vehicle having a belt-driven conical-pulley transmission operatively coupled with a drive engine and with drive wheels of the vehicle; and interrupting a torque-transmitting engagement between the transmission and the drive engine of the vehicle when torque acts on the transmission in a direction from the drive wheels of the vehicle and there is no hydraulic pressure acting on the belt-driven conical-pulley transmission.

2. A method in accordance with claim 1, including the step of restoring the torque-transmitting engagement by supplying hydraulic pressure to the transmission.

3. A conical disk pair for a belt-driven conical-pulley transmission, said conical disk pair comprising:
an input shaft that is rigidly connected to a fixed disk;
a movable disk that is positioned on the shaft so that it is axially movable relative to the shaft and is rotationally fixed thereto;
an input component that is drivable by a drive engine,
a torque sensing unit including a first component that is engaged with the input component to transmit torque and that carries first shaped surfaces, and a second component that is engaged with the movable disk to transmit torque and that carries second shaped surfaces, and
roller bodies positioned between the shaped surfaces,
wherein the shaped surfaces are formed so that when the torque operating between the shaped surfaces increases, the shaped surfaces move apart against a force pressing the shaped surfaces toward each other by rolling on the rolling bodies positioned between them, wherein the shaped surfaces are formed so that when there is little or no force pressing them together, they move apart so that the rolling bodies overrun the shaped surfaces and the transmission of torque between the first component and the second component is interrupted.

4. A conical disk pair in accordance with claim 3, wherein the transmission of torque can only be interrupted when torque is acting from the movable disk.

5. A conical disk pair in accordance with claim 3, wherein the first component is an annular component connected in a rotationally fixed connection with an input wheel mounted on the input shaft and on whose face turned away from the input wheel the first shaped surfaces are formed, and the second component is a sensing piston that surrounds the input shaft and is axially movable relative to the input shaft; and a pressure chamber is positioned between the sensing piston and the movable disk and into which a supply channel for hydraulic pressure leads from an hydraulic pressure source and from which a discharge channel extends, and wherein the effective cross-sectional area of at least one of an input opening of the supply channel and a discharge opening of the discharge channel is changed by the axial position of the sensing piston on the input shaft.

6. A conical disk pair in accordance with claim 3, wherein the rolling bodies are balls and are retained in a cage.

7. A conical disk pair in accordance with claim 6, wherein the shaped surfaces extend radially outwardly to substantially flat tracks formed without ramps, and the balls are radially movable relative to the shaped surfaces so that when there is no hydraulic pressure acting on the movable disk and at high rotational speeds of the torque sensing unit the balls run on the flat tracks as a result of centrifugal force.

8. A conical disk pair in accordance with claim 6, wherein the balls are pre-tensioned axially in the direction of pockets that are formed in at least one of the first and the second shaped surfaces.
